(19) United States
(12) Patent Application Publication
(10) Pub. No.: US 2016/0170494 A1
(43) Pub. Date: Jun. 16, 2016

(54) METHOD AND DEVICE FOR REMOTE CONTROL OF A FUNCTION OF A VEHICLE

(71) Applicant: DAIMLER AG, Stuttgart (DE)

(72) Inventors: Christophe BONNET, Leinfelden-Echterdingen (DE); Andreas HILLER, Stuttgart (DE); Gerhard KUENZEL, Benningen (DE); Martin MOSER, Fellbach (DE); Heiko SCHIEMENZ, Stuttgart (DE)

(73) Assignee: Daimler AG, Stuttgart (DE)

(21) Appl. No.: 14/907,777

(22) PCT Filed: May 21, 2014
(86) PCT No.: PCT/EP2014/001374

§ 371 Date: Jan. 26, 2016

(30) Foreign Application Priority Data
Jul. 26, 2013 (DE) 10 2013 012 394.1

(51) Int. Cl. G06F 3/01; G05D 1/00; G06F 3/041

(52) U.S. Cl. CPC G06F 3/017; G06F 3/0416; G05D 1/0011

(57) ABSTRACT

A method and a device for the remote control of a function of a vehicle is disclosed. A wireless communication connection is established between a portable operating device and the vehicle. A gesture executed by a user is detected by the portable operating device and transmitted, for controlling the function, to the vehicle by the communication connection. The function is executed if the detected gesture corresponds to a predefined gesture allocated to the function. The predefined gesture corresponds to a continuous movement and the function is executed only as long as the gesture executed by the user is detected.

### BACKGROUND AND SUMMARY OF THE INVENTION

The present invention relates to a method and a corresponding device for remote control of a function of a vehicle by means of a portable or mobile operating device.

The invention furthermore relates to a device for the entry of the graphically guided gesture, wherein a function of a vehicle is controlled by means of the gesture.

In DE 102004004302 A1, a mobile device for remote control of an air-conditioning system of a vehicle is described. The mobile device communicates with a control device in the vehicle. Operating commands or operating instructions can be entered via a touch-sensitive display (touch panel display) on the mobile device. On receipt of a corresponding operating instruction from the operating device, either a ventilation of the passenger compartment or air-conditioning of the passenger compartment is executed.

In DE 102009019910 A1, gesture recognition by the processing of a temporal sequence of position entries is described, which are received via a touch sensor, such as, for example, a capacitive or resistive touch sensor. Here, a state machine gesture recognition algorithm is specified to interpret streams of coordinates emitted from a touch sensor.

In DE 112006003515 T5, a method for controlling an electronic device having a touch-sensitive display device is described. Here, the method comprises: detecting a contact using the touch-sensitive display device while the device is located in a locked state of a user interface; moving an image corresponding to an unlocked state of a user interface of a device in accordance with the contact; transferring the device into the unlocked state of the user interface if the detected contact corresponds to a predefined gesture; and maintaining the device in the locked state of the user interface if the detected contact does not correspond to the predefined gesture.

A method is known from EP 1 249 379 A2 to bring a motor vehicle into a target position. Here, the motor vehicle is brought into a start position close to the intended target position. After a first activation on the part of the driver, the surroundings of the motor vehicle are continuously scanned and the current vehicle position is continuously determined. A trajectory to the target position is determined by means of the determined surroundings and position information. To drive the trajectory, control information for bringing the motor vehicle into the target position is generated. After a second activation on the part of the driver, the control commands which are dependent on the control information are emitted to the drive train, the braking system and the steering system of the motor vehicle. The motor vehicle thereby drives independently of the driver into the target position. The activation on the part of the driver can take place outside the vehicle.

In DE 10 2009 041 587 A1, a driver assistance device is described. The control device emits control signals to a drive and steering device of the motor vehicle and causes an execution of an autonomous parking procedure. Commands can be emitted to the control device from outside the vehicle by means of a remote control. After receiving a predetermined interruption command, an already begun parking procedure of the motor vehicle can be interrupted. A camera is coupled to the control device and obtains image data concerning a surrounding region of the motor vehicle. The control device transmits the image data obtained by the camera or image data calculated from this to the remote control. The remote control presents this image data by means of complex display and operating units.

As shown in prior art, touch-sensitive display and operating surfaces (also known as “touch screens”) are always more popular for use as display and user entry devices in portable devices such as smartphones or tablets. In this instance, graphics and text are displayed and a user interface is provided, with which a user can interact with the devices. A touch-sensitive display and operating surface detects and reacts to a touch on the operating surface. A device can display one or more virtual buttons, menus and other user interface objects on the operating surface. A user can interact with the device by touching the touch-sensitive display and operating surface at positions which correspond to the user interface objects with which he would like to interact. Therefore, for example, an application running on such devices can be started. Additionally, different gestures can also be used for clear operation, such as, for example, unlocking by a swiping gesture or a specific unlocking gesture. Besides combined touch-sensitive display and operating surfaces, there are also touch-sensitive operating surfaces which are detached from the displays, such as, for example, in laptops.

To trigger or activate the function of the vehicle outside the vehicle, such as the locking or unlocking or the opening and closing of vehicle doors, the switching on or off of air-conditioning systems of the vehicle, the activation of radio or navigation systems etc., nowadays this is executed mainly with the aid of specific devices. The reason for this is the high safety requirement during the remote control of the vehicle function. If, in this instance, a device is used having a touch-sensitive display and operating surface, the main problem here is the unintentional activation or deactivation of functions due to unintentional contact with the operating surface. Furthermore, there is only a weak haptic feedback to the user during operation. In order to be certain as to whether a determined function is triggered or not, the user must constantly watch the display and operating surface. A monitoring during the execution of the vehicle function is therefore able to be executed with difficulty due to the constant eye contact with the operating surface. For example, during the execution of a parking procedure outside the vehicle, the user is to always keep the driving vehicle in his field of vision in order to be able to bring the vehicle to a standstill in the event of an emergency.

If the user uses his own mobile devices such as a mobile telephone to control vehicle functions, the safe operation is even harder to guarantee. Such electronic devices are consumer electronics and are not designed for the operation of vehicle functions with regard to safety. The functionality is susceptible to faults and the communication with the vehicle can be easily manipulated.

It is therefore the object of the invention to specify an improved method and improved devices for remote control of a function of a vehicle and for entry of the graphically guided gesture over prior art.

In order to be able to control a function of a vehicle outside the vehicle, different gestures are allocated to control different vehicle functions. In other words, the vehicle functions can only be activated or triggered if the corresponding gesture is executed by the user. These gestures to be executed are referred to as “predefined gestures”.

The allocation between the gestures and the vehicle function are stored in the vehicle, for example in a memory unit in the vehicle. Both the raw data of the gestures and determined decision criteria for the gesture can be stored. The allocation between the gestures and the vehicle function can also be stored. Likewise, this allocation or these decision criteria of the gestures can also be stored in the portable operating device. The vehicle functions can only be activated or triggered if the corresponding gesture has been executed by the user or the executed gestures correspond to the corresponding criteria.

The predefined gestures can be fixed or dynamically changeable gestures which, for example, fulfil the following criteria: The gesture must have a determined shape, the gesture must occur at a determined position of the operating field, the shape or position of the gesture is predetermined by the vehicle. Likewise, the vehicle can generate the gesture itself. For example, to activate a vehicle function, a sequence of numbers (e.g. 3547) is stored in the memory unit, wherein the sequence of numbers must be entered by means of a known gesture (e.g. by swipe gesture in a line or consecutive typing in the fields). Additionally, the shape or position of the gesture to be executed can change during each operation. The current state of the vehicle can thus be considered and the “predefined gestures” to be executed are adapted accordingly.

The complexity of the gestures can vary depending on the vehicle function. For example, more complex gestures or patterns can be allocated for safety-critical functions such as “issuing the access or driving authorization” and simple gestures can be allocated for functions such as “switching the air-conditioning on and off”.

In order to control a vehicle function, a user executes a gesture (“executed gesture”) on the portable operating device, for example, by a determined movement instead of only touching a touch-sensitive operating surface of the portable operating device. This “executed gesture” is detected by means of the portable operating device (as a “detected gesture”), for example using an integrated gesture detection. Here, different courses of the parameters such as the position, the pressure or the movement of a guiding object, for example of a finger, on the operating surface are detected during an expected gesture.

Different detection technologies can be used during detection of the gesture. The techniques used most frequently are passive and active capacitive detection. Here, the position of a finger on the operating surface is determined by means of the electrical capacity. Further detection technologies are techniques which are based on resistive screens and usually are operated with a pen, or which are based on ultrasound or other acoustic techniques or techniques which are based on total internal reflection or other optical effects. All these techniques can be used for the detection of the gesture in the present invention.

Generally, so-called raw data of the gesture (e.g. the position, the pressure or the movement of the guiding object, e.g. of a finger) is recorded and stored in the gesture detection. Here, the raw data of the gesture comprises, for example, the coordinates (x,y) of the touch position of a finger on the operating surface, the touch course, the speed of the touch course or the directional change of the touch course.

In order to identify the executed gesture, the detected raw data is transferred to the vehicle by means of the wireless communication connection and is analyzed and evaluated there in the vehicle.

For the evaluation in the vehicle, predefined gestures or the raw data of the predefined gestures or decision criteria for the evaluation are stored in a memory unit in the vehicle or in a control unit of the vehicle. Different gestures are allocated for the control of different vehicle functions. The transmitted raw data of the detected gesture is compared to the stored predefined gestures or is evaluated with the decision criteria for the gesture recognition in the vehicle. If the transmitted raw data corresponds to the stored gesture or the decision criteria, the corresponding vehicle function is executed.

Due to the detection of a gesture executed by a user, instead of only a touching, the risk of an unintentional activation of vehicle functions is greatly reduced. No function can be triggered due to unintentional contact with the operating surface. Therefore, higher operating safety is able to be achieved.

Due to the transmitting of the detected gesture from the portable operating device to the vehicle, the functionality of the portable operating device can be monitored. The raw data of the gestures can only be transferred as long as the communication connection between the portable communication device and the vehicle exists.

The comparison of the detected gesture and the predefined gestures in the vehicle is independent of the gesture recognition of the portable operating device. Therefore, a simple operating device can likewise be used for the control of the vehicle function. In the operating device, only a gesture detection, not a gesture recognition, is required.

Preferably, the gesture recognition can be executed both by the portable operating device and by the vehicle. The detected gesture can be recognized independently of one another and can be allocated to a gesture movement. By means of gesture recognition integrated into a smartphone or tablet, for example, typing, dragging, pressing, longer dragging and variable dragging gestures can be detected and recognized. Here, the executed gestures are allocated to a gesture movement (so-called swiping, sliding, rotating, zooming, etc.). It is not only the transmitted raw data of the detected gesture, but also the results of the gesture recognition, i.e. the allocated gesture movement, which are transferred during the transmitting to the vehicle by means of the communication connection. The transmitted raw data of the detected gesture is evaluated in the vehicle, for example by means of a vehicle-specific gesture recognition. The results of this vehicle-specific gesture recognition, the gesture movement allocated by the vehicle, are compared to the transmitted gesture movement. If both the raw data of the recognized gestures and the gesture movements corresponds to each other, then the corresponding vehicle function is executed.

Due to the transmitting of the detected gesture and the gesture movement from the gesture recognition from the portable operating device to the vehicle, a multiple checking of the gesture recognition takes place. The functionality of the portable operating device can be ensured by the communication between the portable operating device and the vehicle. A manipulation can be prevented both in the portable operating device and in the vehicle.

Preferably, the wireless communication connection between the portable operating device and the vehicle is a Bluetooth connection. Further wireless connections can be any radio connection, for example a wireless local area network (WLAN) connection or a mobile radio communication connection. Any radio communication standard can be used. Depending on the availability of the communication connection, the system can be easily adapted.

Preferably, during transmitting of the detected gesture to the vehicle, the following data is transferred: the touch course or coordinate course of the detected gesture or the speeds of the touch course or the directional change of the touch course on the touch-sensitive display and operating surface or the gesture movement recognized by the portable operating device.

Therefore, different information can be transferred depending on the types of gestures. This simplifies the transfer by, for example, only the information which characterizes the property of the gestures being transferred.

Likewise, different information of the same gestures can be transferred at the same time. These pieces of information can be evaluated independently of one another. The redundancy increases the functional safety of the remote control of the vehicle function. A secure gesture recognition is possible, above all in the case of complex gestures.

Depending on the types of vehicle function, the function is either activated and executed after the gesture has been executed, or is executed as long as the gesture is executed. For a vehicle function which is to be monitored by a user during executed, for example during opening of a convertible roof, driving the vehicle forwards and backwards, the function of the vehicle is only executed as long as the executed gesture is detected by means of the operating device. Thus, for example, any continuous movement must be executed on the operating surface. This continuous movement can be circular, swiping back and forth without stopping, a swipe in one direction with stopping of the finger, etc. A constant pressing of an operating surface during operation such as in the case of a dead man's trigger is not sufficient. This is particularly important for the executed of functions relevant for driving safety such as, for example, the vehicle entering and exiting a parking space. The function of the vehicle is only executed if a continuous or constant movement is detected on the operating surface. Additionally, the gesture must be transferred to the vehicle and checked almost in real time (“real time like”).

The risk of unintentional operating errors is therefore effectively prevented. The operating safety and the monitoring are ensured by a simple operating gesture.

The device for remote control of a function of a vehicle comprises a portable operating device, a wireless communication connection between the portable operating device and the vehicle. Here, the portable operating device comprises a touch-sensitive display and operating surface and a gesture detection. Likewise, the portable operating device can have a gesture recognition. In this instance, the gesture detection and the gesture recognition can be executed separately or in an integrated manner. A gesture executed by the user on the touch-sensitive display and operating surface can then be detected or recognized by means of an integrated gesture recognition of the operating device.

Such gesture recognition has been used for many years in operating devices having touch-sensitive operating surfaces. An early example of this is character recognition in PDAs and a dragging finger movement and the single and double tapping on the touch pad of a notebook. Recently, the gesture recognition has been integrated into a smartphone or tablet. Tapping, dragging, pressing, long dragging and variable dragging gestures (swiping, sliding, rotating, zooming, etc.) are recognized by different parameters such as the position, the pressure or the movement of a guiding object, for example a finger, on the operating surface being analyzed during an expected gesture.

Likewise, the display and operating surface can be a so-called “multi-touch pad”. This operating surface is, for example, able to be operated simultaneously with several fingers. Therefore, one or more touch contacts and movements can be detected. It is conceivable, by means of such an operating surface, to only then execute a vehicle function if several operating gestures are executed at the same time.

The portable operating device is located outside the vehicle, such that a user can control the vehicle or a vehicle function conveniently from the outside. The operating device can be a hand-held computer, a tablet, a mobile telephone, a media player, a personal digital assistant (PDA) or a wireless remote control device.

A memory unit is in the vehicle. Predefined gestures which are allocated to control the function of the vehicle are stored therein. Furthermore, the vehicle has a control unit which can execute the function of the vehicle. The allocation between the gestures and the vehicle function, the raw data of the gestures or determined decision criteria for the gesture can be stored in the memory unit. This data is dynamically changeable. An algorithm to generate or change certain decision criteria for the gesture can also be stored in the memory unit.

Therefore, not only the allocation between the gesture and the vehicle function can be changed, but also the “predefined gestures” to be executed can be changed. The vehicle can generate gestures itself. The shape or position of the gesture to be executed changes during each operation. The current state of the vehicle can be considered and the operation can be adapted accordingly. The user can define gestures himself. A flexible allocation is able to be achieved. The operation can be designed to be user-friendly.

Preferably, the memory unit can be secured in the vehicle or in a control unit of the vehicle, where the predefined gestures to control the function of the vehicle are stored. Preferably, access to the memory unit can occur in the vehicle only with authorization by the vehicle manufacturer. The storage of the predefined gestures can also take place in a separate secure region in the vehicle or in the control unit of the vehicle, such that access is only possible with corresponding authorization. This enables high safety and, at the same, high availability of the operating data for the control of the function of the vehicle. The allocation between the predefined gestures and the vehicle functions can, for example, be stored in a database server of the vehicle manufacturer for the vehicle or for the control unit of the vehicle. The allocation can be changed with corresponding authorization. On the one hand, flexible management is possible. On the other hand, the control of the vehicle function is secured against unauthorized manipulation.

The gesture detected by the portable operating device is transmitted to the vehicle by means of the communication connection. There, the detected gesture is recognized with a vehicle-specific gesture recognition.

For the gesture recognition in the vehicle, for example, the transmitted raw data of the detected gestures is evaluated in an evaluation unit. Like the memory unit, the evaluation unit can be secured against unauthorized access. Due to the comparison of the raw data of the detected gesture with the stored predefined gesture or with the stored decision criteria, it is determined whether the detected gesture is applicable to control a vehicle function. If so, the corresponding vehicle function is executed by means of the control unit of the vehicle.

A gesture is recognized as a valid gesture if determined decision criteria are fulfilled. These criteria can, for example, consist in the gesture having a determined shape, or being executed at a determined position of the operating surface, or changing during each operation or corresponding to a continuous movement, or being vehicle-specific.

The components referred to above (gesture detection, gesture recognition, memory unit, control unit) can be implemented in hardware, software or a combination of both hardware and software.

To enter the gesture which is allocated to control the function of the vehicle, a graphical guide can be depicted on the touch-sensitive display and operating surface. The function of the vehicle is only executed if the executed gesture is detected within the graphical guide and corresponds to the predefined gesture for this vehicle function.

An example is an entry field having numbers from 0 to 9. To activate a vehicle function, a 4-digit number sequence (e.g. 3569) is to be entered. If a gesture such as, for example, a swiping gesture, is executed in a line of 3 to 9, the vehicle function is activated. This path can be displayed in colour, stored on the operating surface. A gesture such as a typing in one after the other of the fields can be displayed in a guided manner. The graphical guiding can additionally be adapted accordingly to the current state of the vehicle.

The operation is user-friendly due to the visual depiction of the graphical guide. The user can easily execute the required gesture. The detection is limited to the region of the graphical guide. Unintentional contact on the operating surface outside the graphic guide is not detected and therefore not transferred to the vehicle, therefore no transfer of unnecessary data.

The device to enter the graphically guided gesture on the touch-sensitive display and operating surface comprises a graphical guide with several end positions. The end positions are connected via connection paths.

An example of this is the selection of the gearbox setting. In this instance, the end positions reflect the gearbox settings from a shift gate. If a gesture is executed from an end position to another end position along the connection path, the corresponding gearbox position in the vehicle is adjusted. The graphical guide is in this case a symbolized shift gate.

Preferably, a switching lever of the vehicle gearbox is depicted as an image element, for example a moveable point on the touch-sensitive display and operating surface. Here, the image element can display the current switch state. If a gesture is executed along a connection path between two end positions, the image element moves with it. The corresponding gearbox position is adjusted in the vehicle if the image element has achieved the corresponding end position. Therefore, the function “gear change” can be controlled by means of the portable operating device. The image element thus displays the current state of the vehicle.

Therefore, this device is not only user-friendly, intuitive and easy to operate, but also ensures the safety for the vehicle-specific operation.

There are now different possibilities to design and develop the teaching of the present invention in an advantageous manner. For this purpose, on the one hand, reference is made to the subordinate claims and on the other hand to the explanation below of the embodiment. The advantageous embodiments are also to be included which result from any combination of the sub-claims.

Likewise, the teaching of the present invention is not only limited to remote control of a vehicle function; the corresponding devices and methods can also be used for remote control of any machine and system.

The present invention is explained in more detail below by means of several exemplary embodiments with reference to the enclosed drawings. It should be noted that the drawings show preferred embodiments of the invention, but these are not limiting.

### BRIEF DESCRIPTION OF THE DRAWINGS

FIG. 1 illustrates a basic structure of a device for remote control of a vehicle function according to one exemplary embodiment of the present invention;

FIG. 2 is a flow diagram of a method for remote control of a vehicle function after execution of a complete gesture according to one exemplary embodiment of the present invention;

FIG. 3 is a flow diagram of a method for remote control of a vehicle function during execution of a gesture according to one exemplary embodiment of the present invention; and

FIG. 4 illustrates a device to enter a graphically guided gesture according to one exemplary embodiment of the present invention.

### DETAILED DESCRIPTION OF THE DRAWINGS

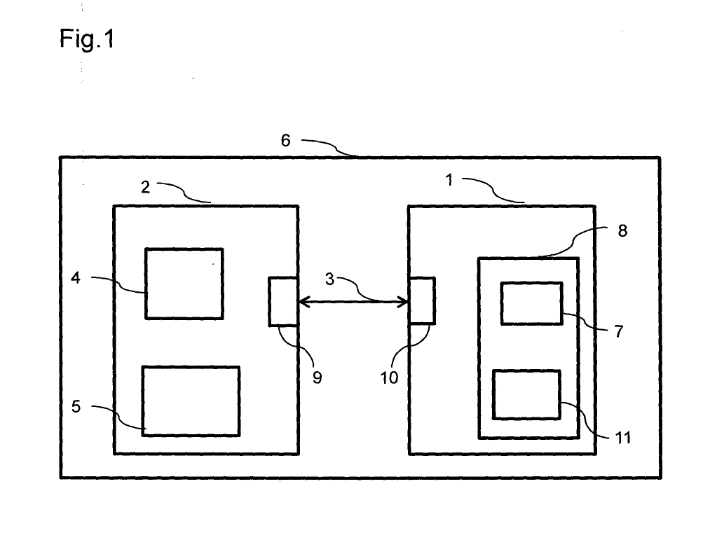

FIG. 1 illustrates a device 6 for remote control of a function of a vehicle 1 according to one exemplary embodiment of the invention. The device 6 comprises the vehicle 1, a portable operating device 2 and a wireless communication connection 3 between the portable operating device 2 and the vehicle 1.

The portable operating device 2, here for example formed as a mobile telephone, is located outside the vehicle 1, such that a user can control the vehicle 2 or a vehicle function conveniently from outside.

In order to be able to communicate with the vehicle 1, the mobile telephone 2 has a wireless communication interface 9, for example a Bluetooth interface 9. The mobile telephone 2 communicates with the Bluetooth interface 10 of the vehicle 1 via this interface 9. Data can be transmitted, transferred and received via the Bluetooth connection 3. Furthermore, the functionality of the mobile telephone 2 can be monitored by the data transfer via the Bluetooth connection 3.

The mobile telephone 2 has a display and operating surface 4 to operate the remote control. Here, the display and operating surface 4 is a touch-sensitive flat display (“touch screen” display) using which the control commands to control the vehicle function are entered. The mobile telephone user executes, for example with his finger, a gesture on the touch screen 4. The executed gesture is detected by means of a gesture recognition 5 integrated into the mobile telephone 2. Here, so-called raw data of the gesture is recorded and stored in a memory in the gesture detection 5 and subsequently evaluated. The raw data of the gesture can thus, for example, be the course of the coordinates (x, y) of the touch of the finger on the touch screen 4. Both the raw data and the evaluation result of the mobile telephone are transferred by means of the Bluetooth connection 3 to the vehicle 1 and evaluated in the vehicle 1.

For the evaluation in the vehicle 1, predefined gestures or the raw data of the predefined gestures are stored in a memory unit 7 in the vehicle 1 or in a control unit 8 of the vehicle 1. Different gestures are allocated to different vehicle functions. Preferably, the access to the memory unit 7 in the vehicle 1 in which the predefined gestures are stored to control the function of the vehicle 1 can be secured. The memory unit 7 can, for example, only be described and read with an authorization by the vehicle manufacturer. This memory unit 7 can also lie in a separate secure region in the vehicle 1 or in the control unit 8 of the vehicle 1, such that access is only possible with corresponding authorization.

For the gesture recognition in the vehicle, the transmitted raw data is evaluated in an evaluation unit 11. Like the memory unit 7, the evaluation unit 11 can be secured against unauthorized access. Due to the comparison of the raw data of the executed gesture with the raw data of the stored predefined gesture, it is determined whether the executed gesture for control of a vehicle function is valid. If the pieces of data corresponds to each other, then the corresponding vehicle function is executed by means of the control unit 8 of the vehicle 1.

A gesture is recognized as a valid gesture if certain criteria are fulfilled. These criteria can, for example, consist in the gesture corresponding to a certain shape, or being executed at a certain position of the operating surface, or changing during each operation, or corresponding to a continuous movement, or being vehicle-specific.

For the entry of the gesture for the control of the vehicle function, a corresponding operating display can be displayed on the touch screen 4 of the mobile telephone 2.

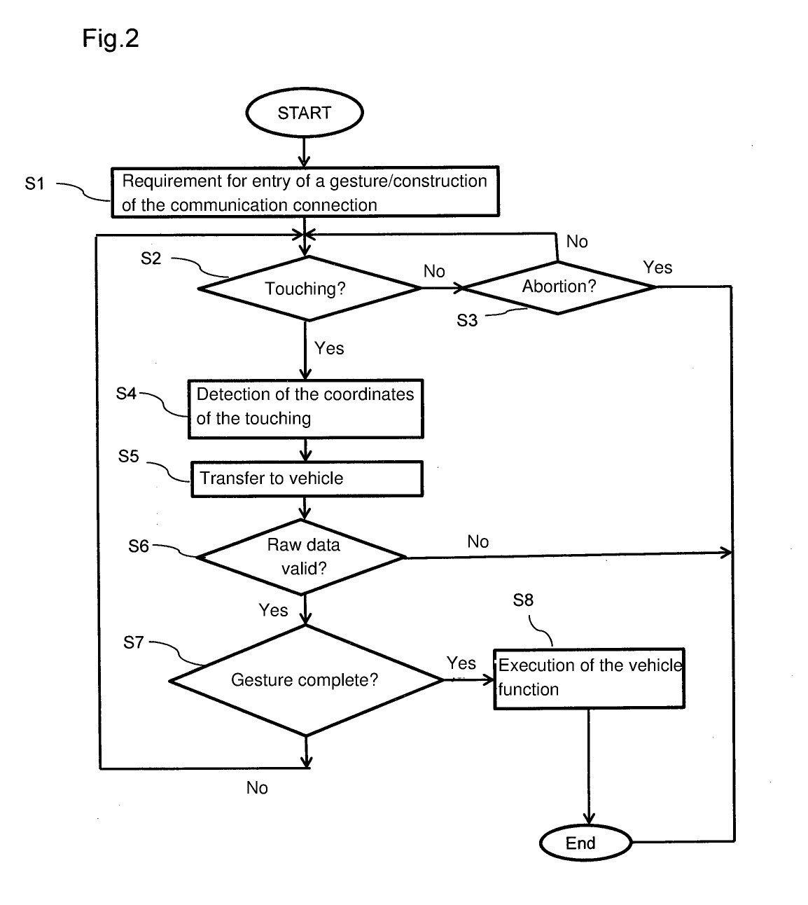

FIG. 2 shows a flow diagram of a method for remote control of a vehicle function after execution of a complete gesture according to one exemplary embodiment of the present invention. Here, the vehicle function is only started if a corresponding gesture, for example on the touch screen 4 of the mobile telephone 2, is executed completely.

In a step which is not depicted here, a user selects an application such as, for example, “engine start” on his mobile telephone 2. The corresponding application program is started.

In step S1, an operating display appears on the touch screen 4 of the mobile telephone 2 to enter determined gestures for the control of the vehicle function “engine start”. This display can be depicted in text form or visually as a graphical guide on the touch screen 4. For this exemplary embodiment, the display, for example, can be displayed as a text “please enter numbers 9541” or as an image on the touch screen.

At the same time, a wireless communication connection 3, here a Bluetooth connection, is established between the mobile telephone 2 and the vehicle 1. Therefore, the control commands to control the vehicle function or the executed gesture which the mobile telephone user has executed with his finger on the touch screen 4 can be transferred to the vehicle 1.

In step S2, it is determined whether a touching of the touch screen 4 is detected or not. If no touching is detected, which corresponds to an answer “no” in step S2, the process sequence advances to step S3. If a touching is detected, which corresponds to an answer “yes” in step S2, the process sequence advances to step S4.

In step S3 it is determined whether a predetermined abortion condition is fulfilled or not. The predetermined abortion condition can, for example, be that no gesture has been detected on the touch screen 4 for a predetermined time period T1. If the predetermined abortion condition is fulfilled, i.e. no touching is detected within the time period T1, which corresponds to an answer “yes” in step S3, the method is aborted and ended. If the abortion condition is not fulfilled, which corresponds to an answer “no” in step S3, the process sequence returns to step S2. The corresponding operating display to enter determined gestures is furthermore displayed on the mobile telephone 2 and the user can continue his gesture or specify it again.

In step S4, the so-called raw data of the gesture, for example as a course of the coordinates of the executed touching, is detected and evaluated by the gesture detection 5 in the mobile telephone 2.

In step S5, the raw data of the executed gesture is transferred to the vehicle 1 via the Bluetooth connection 3. Likewise, the evaluation result from the gesture recognition 5 of the mobile telephone 2 is transferred with it.

In step S6, it is determined whether the raw data of the executed gesture is valid or not. In other words, the raw data is evaluated in the vehicle 1, independently of the gesture recognition 5 in the mobile telephone 2 in the vehicle-specific gesture recognition 11. It is thereby checked, for example, whether the evaluation result corresponds with the stored predefined gestures. If “yes”, the allocated vehicle function is executed in step S7. If “no”, the method is aborted and ended.

In step S7, it is determined whether the executed gesture is complete. If it is, the process sequence advances to step S8, and the vehicle function is activated. Here, the engine of the vehicle is started. If not, the process sequence returns to step S2. In other words, as long as a movement of the touching is detected on the operating surface, the coordinates of the raw data are detected in step S4, and transferred to the vehicle in step S5 and checked there for their validity until the executed gesture is complete.

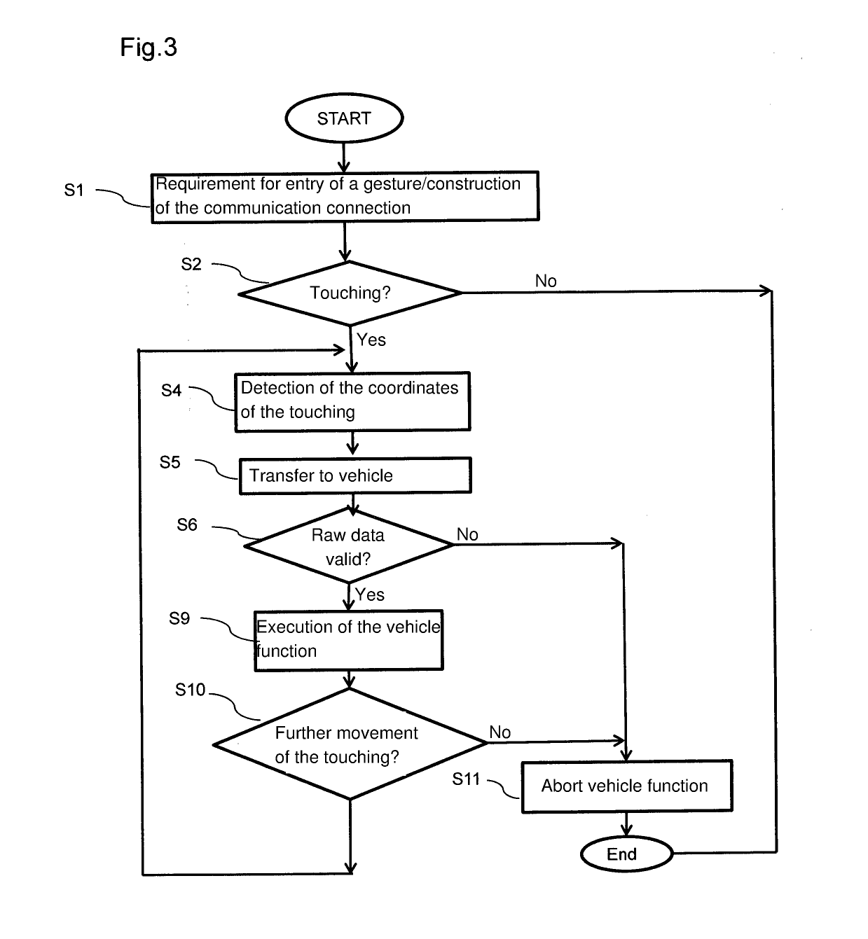

FIG. 3 shows a flow diagram of a method for the remote control of a vehicle function during execution of a gesture according to one exemplary embodiment of the present invention. Here, the vehicle function is only started as long as a corresponding gesture is executed, for example on the touch screen 4 of the mobile telephone 2. This is necessary for the executed of a procedure for which monitoring is important.

In a step which is not depicted here, a user selects an application such as, for example, “opening a convertible roof” or “driving” on his mobile telephone 2. The corresponding application program is started.

In step 51, an operating display appears on the touch screen 4 of the mobile telephone 2 to enter certain gestures for the control of a procedure of the vehicle such as “opening a convertible roof” or “driving”. This display can be depicted in text form or visually as a graphical guide on the touch screen 4. For this exemplary embodiment, the display can, for example, be displayed as a text “please execute a continuous circling movement”. Likewise, a circular image can be depicted on the touch screen as a display in order to clarify to the user that the touch screen is now to be operated in a circular movement. The circular movement can thus, for example, be executed in one direction, circulating with a directional change or also for example in the form of an 8. For this, the user must operate the touch screen without stopping.

Similar to in FIG. 2, the same step S1 to S6 is executed. A Bluetooth connection is established between the mobile telephone 2 and the vehicle 1 for the transfer of the detected gesture. Provided a touching of the touch screen 4 is detected, the so-called raw data of the gesture is detected, evaluated, and transferred to the vehicle 1 via the Bluetooth connection 3.

In step S6, it is determined whether the raw data of the executed gesture is valid or not. If “yes”, the allocated vehicle function is executed in step S9. If “no”, the process sequence advances to step S11.

During the execution of the vehicle function, in step S10 it is determined whether a further movement of the touching of the touch screen 4 is detected or not. If a movement is detected which corresponds to an answer “yes” in step S10, the process sequence returns to step S4. In other words, as long as a movement of the touching is detected on the operating surface, the coordinates of the raw data are detected in step S4 and are transferred to the vehicle in step S5 and are checked there for their validity.

Additionally, the vehicle can provide feedback to the driver, for example by an acoustic or haptic signal, via the mobile telephone. Additionally, the vehicle and the mobile telephone can evaluate the data of the gesture independently of each other. The results of the evaluation of the mobile telephone are transferred to the vehicle. The vehicle function which is allocated to the gesture is executed only in the case of correspondency of the evaluation results.

If in step S10, no movement of the touching is detected which corresponds to an answer “no” in step S10, the process sequence advances to step S11. The vehicle function is stopped and the method is aborted.

Therefore, the recording and transfer of the raw data of the gesture are started with the detection of a touching of the touch screen 4 and only stopped as soon as no touching is detected any longer. Thus, in step S6, the transmitted raw data is checked for its validity in the vehicle 1. The corresponding assigned vehicle function is executed as long as the transmitted raw data is valid. In the case of invalid raw data, the procedure is aborted immediately. For the example of the control of the vehicle function “opening of a convertible roof” by means of a continuous circular movement on the touch screen 4, the opening of the convertible roof is only executed if the allocated gesture is executed as circulating movement on the touch screen 4. The procedure is immediately stopped if no temporal change of the touch coordinates is detected on the touch screen 4, i.e. during release or during a continuous pressing on the touch screen 4. In this case, in the case of the dead man's switch, the opening of the roof is stopped.

For the function “driving”, the driver executes the rotational movement, and the data of the executed gesture, here the movement course, is transferred to the vehicle via the wireless communication connection. The vehicle evaluates the data, and steers and drives the vehicle. If the driver stops the circular movement, then the vehicle remains stationary. If the vehicle operator starts the circular movement again, then the vehicle drives further. In this instance, the vehicle can recognize obstacles autonomously via the on-board sensor system and can react to these accordingly. In the case of recognition of an obstacle, the vehicle brakes and comes to a stop at a distance from the obstacle. The vehicle can provide the vehicle user with feedback by means of an acoustic or haptic signal. The intensity of the signal can be varied with the distance to the obstacle.

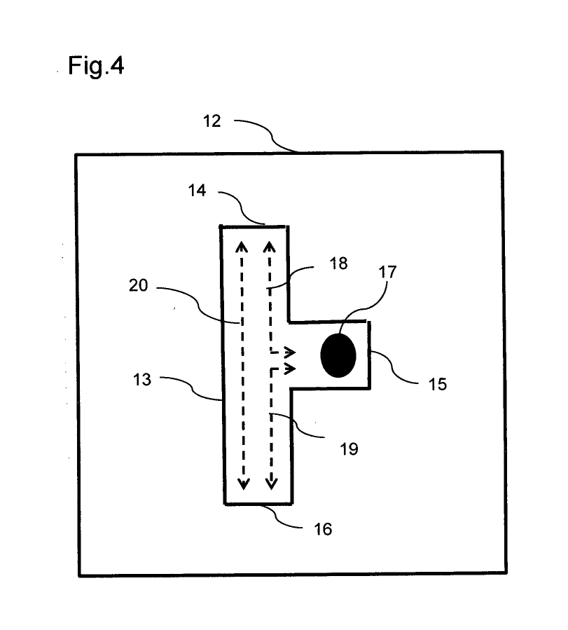

FIG. 4 shows a device to enter a graphically guided gesture. For example, a gear change can be executed via a mobile telephone 2 in a vehicle 1 by means of the graphically guided gesture.

Here, the device comprises a graphical guide 13 having three end positions (14, 15, 16) and one image element 17. The end positions (14, 15, 16), can be achieved via three connection paths (18, 19, 20).

The three end positions (14, 15, 16) correspond to the three gearbox settings of a shift gate. The end position 14 marked with “D” stands for “Drive”, and corresponds to the vehicle function “engage forward gear”. The end position 15 marked with “P” stands for “Park”, and corresponds to the vehicle function “engage parking brake”. The end position 16 marked with “R” stands for “Reverse”, and corresponds to the vehicle function “engage reverse gear”.

The end positions (14, 15, 16) can thus be arranged at a distance with respect to each other in such a way that “D” 14 is arranged on the upper end position of the mobile telephone display 4, “R” 16 is arranged perpendicularly to “D” 14 on the lower end position of the display and “P” 15 is arranged at a right angle in the middle of the distance between “R” 16 and “D” 14.

In this exemplary embodiment, the image element (17) is formed as a filled circle. It corresponds to a gear lever of the vehicle gearbox. The position of the circle (17) shows the current switching status of the vehicle (1) on the mobile telephone display (4). The circle (17) can be moved along the three connection paths (18, 19, 20) to the three end positions (14, 15, 16) by means of a finger. The position of the circle (17) therefore corresponds to the current position of the finger within the graphical guide (13).

The corresponding function of the vehicle is only activated if the gesture is executed from one end position to the other end position within the graphical guide (13) and the circle (17) has reached the corresponding end position. Otherwise, the circle (17) is guided back to its last valid end position and no gear change takes place in the vehicle (1).

In order to be able to enable a gear change, the image element (17) is moved. The movement occurs here via a gesture of the vehicle user from one end position, for example 15, to another end position, for example 14. The movement of the image element (17) must be executed in such a way that it occurs along a connection path (18, 19, 20) and is executed without stopping.

The connection paths can thus be at right angles (18, 19) or in a straight line (20). If the vehicle is to move forwards, for example, from a stopping position (15), the vehicle user must execute a gesture in a line which occurs from “P” (15) at a right angle upwards to “D” (14). In the case of stopping of the image element (17), the image element (17) springs back to its initial position, so here to the stopping position (15), and a gear change does not take place in the vehicle (1).

1.-10. (canceled)

11. A method for remote control of a driving safety relevant function of a vehicle, comprising the steps of:
establishing a wireless communication connection between a portable operating device and the vehicle;
detecting a gesture executed by a user by the portable operating device and transmitting the gesture, for controlling the function, to the vehicle by the wireless communication connection; and
executing the function if the detected gesture corresponds to a predefined gesture allocated to the function;
wherein the predefined gesture corresponds to a continuous movement;
and wherein the function is executed only as long as the gesture executed by the user is detected.

12. The method according to claim 11, wherein the continuous movement corresponds to a circular movement of a finger or a swiping back and forth of the finger without stopping the finger.

13. The method according to claim 11, wherein the function is a function for controlling the vehicle during entering and exiting a parking space.

14. The method according to claim 11, wherein:
the detected gesture is allocated to a gesture movement by the portable operating device and by the vehicle independently of each other;
the gesture movement allocated by the portable operating device in the vehicle and the gesture movement allocated by the vehicle are compared to each other; and
in a case where the gesture movement allocated by the portable operating device in the vehicle and the gesture movement allocated by the vehicle correspond, the function of the vehicle is executed which is allocated to the gesture.

15. The method according to claim 11, wherein the wireless communication connection is a Bluetooth connection or a wireless local area network (WLAN) connection.

16. The method according to claim 11, wherein during the transmitting a touch course traced on a touch-sensitive display and operating surface or a speed of the touch course or a directional change of the touch course or a gesture movement allocated by the portable operating device is transferred from the portable operating device to the vehicle.

17. A device for remote control of a driving safety relevant function, comprising:
a portable operating device, wherein the portable operating device is operable by a touch-sensitive display and operating surface and includes a gesture detection;
a vehicle, wherein the vehicle includes:
a memory unit for storing a predefined gesture that corresponds to a continuous movement and that is allocated to the driving safety relevant function;
a control unit configured to execute the driving safety relevant function, if and as long as the gesture detection detects a gesture that corresponds to the predefined gesture; and
a communication device for establishing a wireless communication connection between the portable operating device and the vehicle.

18. The device according to claim 17, wherein:
the portable operating device includes a graphical guide to enter the gesture; and
the driving safety relevant function is executable if an executed gesture is entered in the graphical guide.

19. The device according to claim 18, wherein the graphical guide reproduces a symbolized shift gate.

20. The device according to claim 17, wherein the device includes a moveable image element and wherein the moveable image element symbolizes a gear lever of a gearbox of the vehicle.
